(19) United States
(12) Patent Application Publication
(10) Pub. No.: US 2008/0110207 A1
(43) Pub. Date: May 15, 2008

(54) Preform Production Apparatus and Preform Production Method

(75) Inventors: Shigeki Fukuda, Kanagawa (JP); Makoto Kidachi, Kanagawa (JP); Ryosuke Sakai, Kanagawa (JP); Futoshi Ishizaki, Kanagawa (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Ohara, Inc.

(21) Appl. No.: 11/793,034

(22) PCT Filed: Dec. 9, 2005
(86) PCT No.: PCT/JP05/22633

§ 371 Date: Jun. 15, 2007

(30) Foreign Application Priority Data
Dec. 16, 2004 (JP) 2004-364919
Feb. 23, 2005 (JP) 2005-047275
Jun. 21, 2005 (JP) 2005-181100

(51) Int. Cl. C03B 11/00; C03B 7/01

(52) U.S. Cl. 65/66; 65/286; 65/292; 65/305

(57) ABSTRACT

A preform manufacture apparatus is provided which can produce a preform at low cost. A preform manufacture apparatus 1 has a first mold 20 which receives molten glass, and a second mold 50 which receives a molten glass block moved from the first mold 20. The first mold 20 has a receiving surface 20A which receives molten glass, and is dividable into two or more of split dies 30 and 40 at the receiving surface 20A.

### TECHNICAL FIELD

The present invention relates to a preform manufacture apparatus and a preform manufacture method, which produce a preform from molten glass in the manufacturing process steps of optical elements, for example.

This application is based on and claims the benefit of priority from Japanese Patent Application No. 2004-364919, filed on Dec. 16, 2004, Japanese Patent Application No. 2005-47275, filed on Feb. 23, 2005, and Japanese Patent Application No. 2005-181100, filed on Jun. 21, 2005, the content of which is incorporated herein by reference.

### BACKGROUND ART

In recent years, for optical elements, such as lenses for a digital camera, for example, an optical lens formed in a predetermined shape is used. In order to manufacture this optical lens highly accurately in large quantities, for example, the following method is known. First, molten glass is used to produce a glass block (hereinafter, referred to as a preform) approximately in the shape of an optical lens, and then, this preform is subjected to hot working with molding tools.

According to this method, since an optical lens is formed through molten glass to a preform, this method provides the advantages that the lead time can be shortened as compared with methods of producing an optical lens in which a glass sheet is subjected to many process steps such as cutting, working, pressing, grinding, and polishing, and reductions in yields caused by defective work can be reduced, and consequently a great reduction in costs can be achieved.

For a preform manufacture apparatus for producing a preform as described above, for example, there is a preform manufacture apparatus having a dropping unit which drops molten glass from the tip end of a nozzle, a lower molding tool which is disposed below the dropping unit to receive the dropped molten glass, and an upper molding tool which is fit to the lower molding tool (see Patent Reference 1).

According to the preform manufacture apparatus, first, molten glass is dropped from the dropping unit to the lower molding tool. Then, the dropped molten glass is received by the lower molding tool to form a molten glass block. After that, the upper molding tool is fit to the lower molding tool to shape the molten glass block for producing a preform.

Patent Reference 1: Japanese Unexamined Patent Application Publication No. Hei 7-165431

### DISCLOSURE OF THE INVENTION

### Problems to be Solved by the Invention

However, in the preform manufacture apparatus described above, molten glass at high temperatures directly contacts the upper molding tool and the lower molding tool. Therefore, in these molding tools, the surface of the lower molding tool is particularly oxidized and roughened soon, and consequently, the surface of the preform on which the surface of the molding tool is transferred looses its shine. In order to solve such a problem, it can be considered to replace the molding tool at an early stage, which takes effort to replace the molding tool, causing the problems that the operating rate of the preform manufacture apparatus is decreased and that manufacture costs are increased.

An object of the present invention is to provide a preform manufacture apparatus and a preform manufacture method which can produce a preform at low costs.

### Means for Solving the Problems

A preform manufacture apparatus according to the present invention is a preform manufacture apparatus including: a first mold configured to receive molten glass; and a second mold configured to receive a molten glass block moved from the first mold, wherein the first mold has a receiving surface which receives molten glass, and is dividable into two or more of split dies at the receiving surface.

According to the present invention, the molten glass is dropped in the state in which the first mold is closed. Then, the dropped molten glass is received by the first mold to form a molten glass block. After that, the molten glass block is moved from the first mold, and the molten glass block is received by the second mold. After that, the molten glass block is shaped in the second mold to produce a preform. Therefore, the molten glass at high temperatures is received by the first mold, the temperature of the molten glass block is lowered, and then the molten glass block is moved to the second mold for shaping. Thus, since the surface of the second mold as a molding tool can be prevented from oxidizing, it is unnecessary to replace the second mold at an early stage, and a preform can be produced at low costs.

In the present invention, the apparatus can also include a dropping unit configured to drop molten glass; and a moving unit configured to move a molten glass block from the first mold to the second mold, wherein the first mold is disposed below the dropping unit, and the second mold is disposed below the first mold.

In the present invention, preferably, the moving unit is configured to open and close the first mold. According to the present invention, since the moving unit is configured to open and close the first mold, a glass block received by the first mold can be easily moved to the second mold.

In the present invention, preferably, the moving unit is configured to open the first mold by rotating the split dies downward. According to the present invention, since the split dies of the moving unit are configured to rotate downward, it is ensured that the split dies can be opened and closed with a simple structure.

In the present invention, preferably, the receiving surface has a shape that is widened and opened from below to above. For example, in the case in which the receiving surface is formed almost horizontally, when the first mold is opened in the state in which a molten glass block is accommodated in the first mold, it is sometimes difficult to accurately drop the molten glass block onto the second mold because the molten glass block is caught by the split dies, and a force is horizontally applied to the surface of the molten glass block.

Then, according to the present invention, since the receiving surface is formed in a shape that is widened and opened from below to above, the application of a horizontal force to the surface of the molten glass block can be prevented, and the molten glass block can be dropped more accurately onto the second mold below. In addition, in the present invention, preferably, the receiving surface has a pyramid shape.

In the present invention, preferably, the receiving surface has a conical shape, and an apical angle of the cone is an angle of 30 degrees or more. Moreover, in the present invention, more preferably, the receiving surface has a conical shape, and an apical angle of the cone is an angle of 150 degrees or less. In addition, more preferably, the apical angle of the cone an angle of 60 degrees or more to 150 degrees or less, yet more preferably, it is an angle of 80 degrees or more to 130 degrees or less, and even more preferably, it is an angle of 90 degrees or more to 120 degrees or less.

In the present invention, preferably, the first mold is formed with a plurality of cavity surfaces, and the receiving surface is selected from the plurality of the cavity surfaces.

In the present invention, preferably, the receiving surface is selected from the plurality of the cavity surfaces by changing the attitude of the first mold.

According to the present invention, since the receiving surface can be selected from a plurality of cavity surfaces by changing only the attitude of the first mold, the frequency of use of the cavity surfaces can be reduced, and the first mold can be used for a long time.

In the present invention, preferably, an opening width of the first mold is 1.2 times the diameter of a desired preform or more. Moreover, the opening width of the first mold is preferably 1.2 times the diameter of a desired preform or more, more preferably, it is 1.3 times or more, and even more preferably, it is 1.4 times or more.

In the present invention, preferably, the receiving surface of one or both of the first mold and the second mold is formed of gold or a gold alloy. By forming the receiving surface of the first of gold or a gold alloy, the wettability between the receiving surface of the first mold and the molten glass block is reduced, and the molten glass block will not easily melt and attach to the first mold. Therefore, sintering and scratches caused by melting and attaching of the molten glass block to the first mold can be prevented. Moreover, the receiving surface of the second mold may be formed of gold or a gold alloy.

In the present invention, preferably, the dropping unit drops molten glass having log η of 7.65 or less (η is the viscosity in poise).

In the present invention, a structure can be configured in which the second mold has a second receiving surface which receives a molten glass block, and the second receiving surface has a shape that is widened and opened from below to above, having an ejection port through which gas is issued under the second receiving surface. Furthermore, in this case, preferably, the second receiving surface has a conical shape. Moreover, the preform manufacture apparatus according to the present invention can produce a spherical preform or a rough sphere for a polished ball.

According to the present invention, a spherical preform can be produced while a molten glass block moved from the first mold is being rotated with gas issued from under the second receiving surface. At this time, the molten glass block can be shaped in the state in which it intermittently contacts with the second receiving surface. Therefore, in shaping the preform, the molten glass block can be shaped in the state in which it is nearly floating on the second receiving surface. Therefore, it can be easily rotated with gas from the ejection port, and a spherical preform can be produced.

Moreover, molten glass can be cut from the dropping unit by the first mold to form a molten glass block, and in this state, the block can be moved to the second receiving surface. Therefore, it will not start to form a preform on the second receiving surface in the state in which strings are produced from the dropping unit, and striae can be prevented by catching and winding strings on the block. Moreover, since molten glass is temporarily received by the first mold and then it is moved to the second mold, a fall of a molten glass block can be shortened. Therefore, the dropping behavior of the molten glass from the dropping unit onto the second mold can be stabilized, and it can be accurately dropped onto the second receiving surface. Furthermore, it is possible to prevent the molten glass block from bouncing out of the second receiving surface due to gas issued from under the second receiving surface.

Moreover, since gas is is possible to prevent gas from issueing from under the second receiving surface by the first receiving surface, the fluctuations and drops in the temperature of the nozzle caused by gas issued from under the second receiving surface can be prevented, and molten glass can be dropped from the nozzle at a stable temperature.

A spherical preform to be produced can be used as a preform for producing an optical element by precision press forming, a rough sphere for a polished ball, or an intermediate product for producing a preform for precision press forming. Moreover, a rough sphere for a polished ball can be used as a preform for producing an optical element after polishing. The spherical preform is not intended to be a perfect sphere in its appearance. For example, it may be a polyhedron with a nearly oval shape, or such a form that in an oval shape, the dimension is partially recessed to have a plurality of planes.

Moreover, a preform manufacture method according to the present invention (for example, as described in claims 18 to 29) expands the preform manufacture apparatus described above (for example, as described in claims 1 to 16) to a preform manufacture method. According to the preform manufacture method, the same advantages can be obtained as those discussed in the preform manufacture apparatus described above.

### Effects of the Invention

In accordance with the preform manufacture apparatus and the preform manufacture method according to the present invention, the following advantage can be obtained. The high temperature molten glass is received and held by the first mold, the temperature of the molten glass block is lowered, and then the molten glass block is moved to the second mold for shaping. Therefore, oxidation of the surface of the second mold as a molding tool can be prevented, and thus it is unnecessary to replace the second mold at an early stage, and a preform can be produced at low cost.

### BRIEF DESCRIPTION OF THE DRAWINGS

FIG. 1 shows a cross section schematically depicting a molten glass block forming apparatus which is a constituent of a preform manufacture apparatus according to an embodiment of the present invention;

FIG. 2 shows an enlarged diagram depicting the state in which a first mold according to the embodiment is opened;

FIG. 3 shows a cross section schematically depicting a press forming apparatus according to the embodiment;

FIG. 4 shows a cross section schematically depicting a state in which a molten glass flow is dropped from a dropping unit to the first mold according to the embodiment;

FIG. 5 shows a cross section schematically depicting a state in which the first mold according to the embodiment is opened;

FIG. 6 shows a cross section schematically depicting a state in which a second mold according to the embodiment is moved to a heating position;

FIG. 7 shows a cross section schematically depicting a state in which a third mold is fit to the second mold according to the embodiment;

FIG. 8 shows a cross section schematically depicting a state in which the second mold according to the embodiment is cooled;

FIG. 9 shows a cross section schematically depicting a state in which a third mold according to a first modification of the present invention is fit to a second mold;

FIG. 10 shows an enlarged diagram depicting a first mold according to a second modification of the present invention;

FIG. 11 shows an enlarged diagram depicting a second mold according to a third modification of the present invention;

FIG. 12 shows a cross section schematically depicting a state in which a first mold according to the third modification of the present invention is opened; and

FIG. 13 shows a cross section schematically depicting a state in which a preform is formed according to the third modification of the present invention.

### PREFERRED MODE FOR CARRYING OUT THE INVENTION

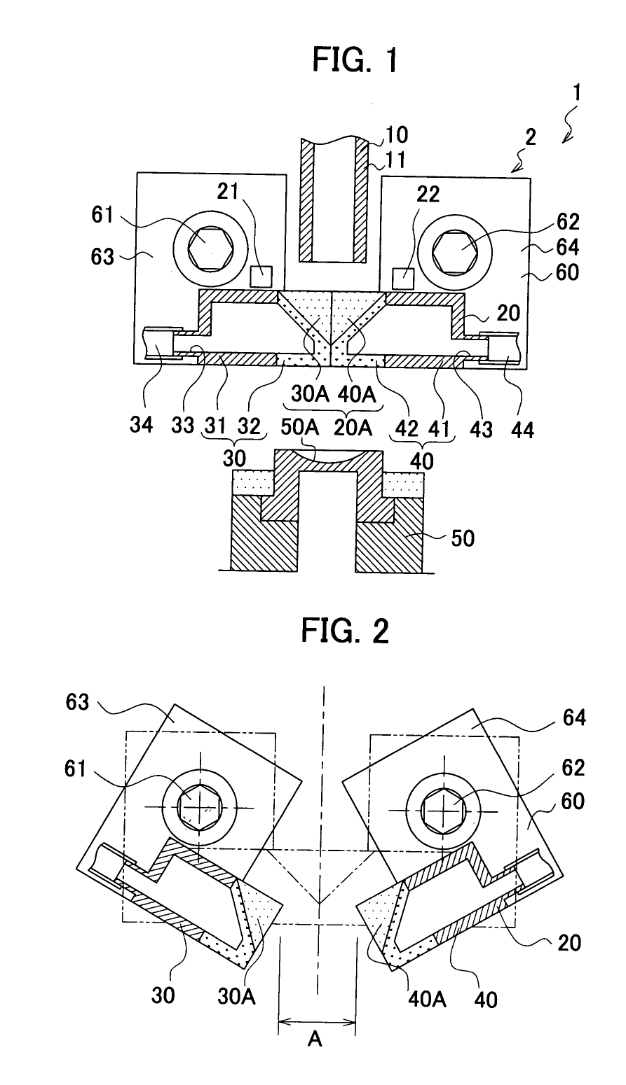

Hereinafter, an embodiment of the present invention will be described with reference to the drawings. FIG. 1 shows a cross section schematically depicting a molten glass block forming apparatus 2 which is a constituent of a preform manufacture apparatus 1 according to an embodiment of the present invention. The molten glass block forming apparatus 2 is a constituent of the preform manufacture apparatus 1 along with a press forming apparatus 3, described later. The molten glass block forming apparatus 2 has a dropping unit 10 which drops molten glass downward, a first mold 20 disposed below the dropping unit 10, an opening/closing mechanism 60 which serves as a moving unit to open and close the first mold 20 and to vertically move it, and a second mold 50 which is disposed below the first mold 20.

The dropping unit 10 is configured to include a glass melting basin, not shown, in which molten glass is accommodated, and a nozzle 11 which is extended from the glass melting basin downward to drop molten glass. In addition, in some cases, a heating unit may be provided which heats molten glass such that the temperature of the molten glass dropping from the nozzle 11 is at a softening point or above. In this case, more specifically, molten glass is heated such that the molten glass dropping from the nozzle 11 has 7.65 of log η (η is a viscosity in poise) or less.

The first mold 20 is disposed below the nozzle 11, which has a receiving surface 20A that receives the molten glass dropped from the dropping unit 10. The first mold 20 is divided into two split dies 30 and 40 at the center. Accordingly, the receiving surface 20A is divided into a receiving surface 30A of the split dies 30 and a receiving surface 40A of the split dies 40.

Moreover, between the nozzle 11 and the first mold 20, a light emitting part 21 which emits visible rays, infrared rays or the like, and a sensor part 22 which detects the emitted rays are disposed. The sensor part 22 detects the light from the light emitting part 21, whereby it detects that the molten glass flow dropped from the dropping unit 10 has been cut.

The split dies 30 and 40 have a box shape with air supply chambers 33 and 43 therein, and each of them is configured of frames 31 and 41, and shaping parts 32 and 42 mounted on the frames 31 and 41. The frames 31 and 41 are formed of a refractory metal, which are formed of stainless steel here. The shaping parts 32 and 42 are formed of a heat resistant porous material, which are formed of a porous metal of sintered stainless steel here. Therefore, although the shaping parts 32 and 42 have a number of micropores throughout the surface, a coating is applied to the portions except the receiving surfaces 30A and 40A to block undesired micropores for the prevention of leakage of air through the micropores. Thus, only the receiving surfaces 30A and 40A have a number of micropores which communicate the air supply chambers 33 and 43 with the outside.

Preferably, in the first mold 20, at least the portions contacted with the receiving surfaces 30A and 40A and the molten glass are gold or a gold alloy. In order to provide gold or a gold alloy on the receiving surfaces 30A and 40A, a film of gold or a gold alloy may be formed on the heat resistant porous material described above by coating, for example. Alternatively, a part or all of the shaping parts 32 and 42 may be formed of gold or a gold alloy. For a gold alloy, for example, those that includes at least one selected from aluminum, silicon, vanadium, chromium, titanium, iron, cobalt, nickel, copper, zinc, germanium, yttrium, zirconium, niobium, molybdenum, ruthenium, lead, silver, tin, hafnium, tungsten and platinum can be mentioned. When a gold alloy is used, preferably, the content of gold is 90% or above. Moreover, when a film of gold or a gold alloy is formed by coating, preferably, the film thickness thereof is 0.1 μm or more to 5 μm or less.

Moreover, around the frames 31 and 41 of the split dies 30 and 40, water cooled tubes, not shown, are disposed which cool the first mold 20. A cooling water supply pipe and a cooling water discharge pipe are connected to each of the water cooled tubes to circulate cooling water therein.

Air supply pipes 34 and 44 are respectively connected to the split dies 30 and 40, which communicate with the air supply chambers 33 and 43. Gas such as air or inert gas is supplied to the air supply chambers 33 and 43 through the air supply pipes 34 and 44, and then the gas is issued from the receiving surfaces 30A and 40A to outside through a number of micropores.

Preferably, the receiving surface 20A has a shape that is widened and opened from below to above, particularly preferably a conical shape. In addition, the shape of the receiving surface may be pyramidal such as a triangular pyramid and a quadrilateral pyramid, and not restricted to a cone.

The opening/closing mechanism 60 has support parts 63 and 64 which support the split dies 30 and 40, rotating shafts 61 and 62 which are mounted on the support parts 63 and 64, and a drive unit, not shown, which rotates and vertically moves the rotating shafts 61 and 62. As shown in FIG. 2, the opening/closing mechanism 60 rotates the two split dies 30 and 40 downward in opposite directions to each other about the rotating shafts 61 and 62, whereby it separates the split dies 30 and 40 apart from each other to open the first mold 20.

In the state in which the first mold 20 is opened, the distance between the split dies 30 and 40, that is, an opening width A of the first mold is determined depending on the outer diameter of the preform obtained. In the embodiment, the opening width A is set to 1.5 times the desired outer diameter of a preform.

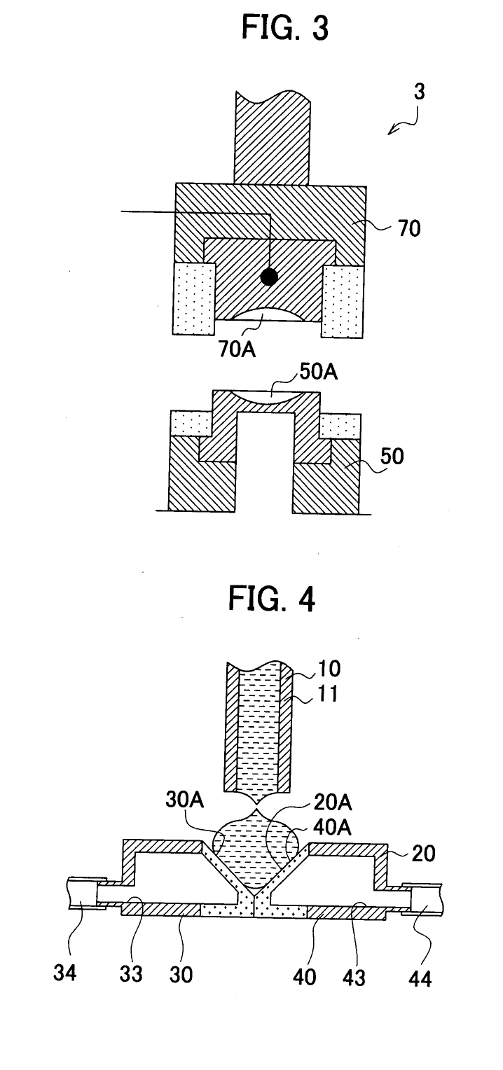

Returning to FIG. 1, the second mold 50 is disposed on a circular rotary table, not shown, and the rotary table is rotated to move the mold between the molten glass block forming apparatus 2 and the press forming apparatus 3. In addition, although a plurality of the second molds 50 is disposed on the rotary table at equal distances, in FIGS. 1 and 3, only a single second mold 50 is shown.

The second mold 50 is formed of a heat resistant metal, which is formed of stainless steel here. The second mold 50 has a recessed second receiving surface 5A. The second receiving surface 50A has a coating of a nitride metal or a carbonized metal, for example. For a nitride metal, for example, titanium nitride, titanium aluminium nitride, and chromium nitride are named. For a carbon metal, for example, titanium carbide, chromium carbide, and tantalum carbide are named. Moreover, the second receiving surface 50A may be formed of gold or a gold alloy. For a gold alloy, the similar metals used for the first mold may be included.

FIG. 3 shows a cross section depicting the press forming apparatus 3 configuring the preform manufacture apparatus I. The press forming apparatus 3 has the second mold 50 described above, a third mold 70 which has a recessed shaping surface 70A disposed above the second mold 50, and a pushing device, not shown, which moves the third mold 70 up and down to fit it to the second mold 50. The second mold 50 is one that has been moved from the molten glass block forming apparatus 2 by the rotary table.

Next, the operation of the preform manufacture apparatus 1 will be described with reference to FIGS. 4 to 8. First, cooling water is circulated through inside the water cooled tubes of the split dies 30 and 40 of the first mold 20 to cool the first mold 20 so as not to sinter molten glass to the receiving surface 20A of the first mold 20.

Subsequently, as shown in FIG. 4, gas is supplied from the air supply pipes 34 and 44 to the air supply chambers 33 and 43, a molten glass flow is dropped from the nozzle 11 of the dropping unit 10 in the state in which gas is issued from the surface of the receiving surface 20A of the first mold 20, and the molten glass flow is received on the receiving surface 20A. The molten glass flow flowing into the first mold 20 is floated and held on the receiving surface 20A. When the molten glass flow reaches a predetermined amount, the opening/closing mechanism 60 moves the first mold 20 downward. The molten glass flow is cut by surface tension to form a molten glass block.

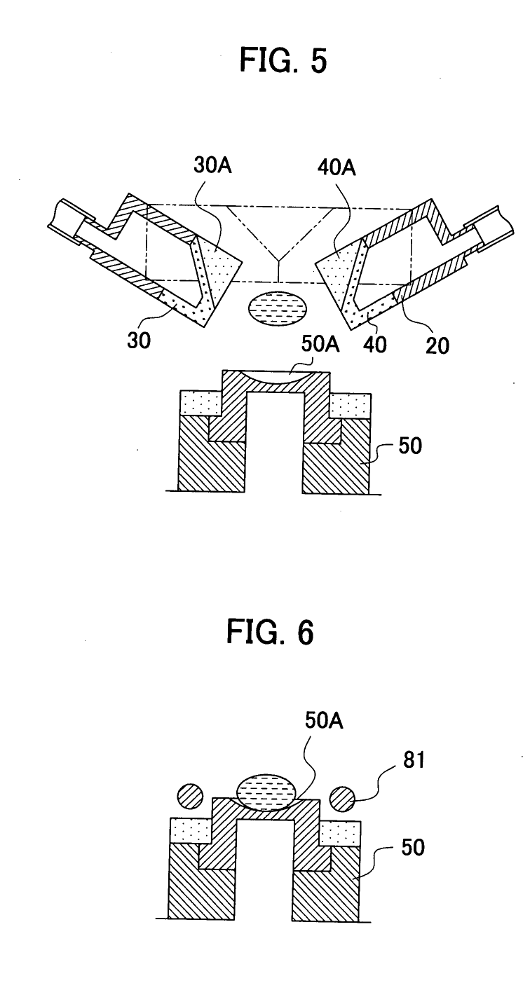

At this time, although strings are produced on the top surface of the molten glass block, after these strings have melted into the molten glass block, as shown in FIG. 5, a detection signal from the sensor part 22 activates the opening/closing mechanism 60 to open the first mold 20, and then the molten glass block is dropped onto the receiving surface 50A of the second mold 50.

Upon the molten glass block being dropped onto the receiving surface 50A, the rotary table is rotated to move the second mold 50 holding the molten glass block from below the first mold 20. At the same time, another empty second mold 50 is positioned below the first mold 20 to be prepared for the next drop of a molten glass block. Moreover, the opening/closing mechanism 60 is operated to close the first mold 20 to be prepared for the next flow of a molten glass flow. Subsequently, as shown in FIG. 6, the second mold 50 holding the molten glass block is moved to the heating position, and the second mold 50 is heated at a temperature of 500 to 700° C. by a heating unit 81 to maintain the softened state of the molten glass block.

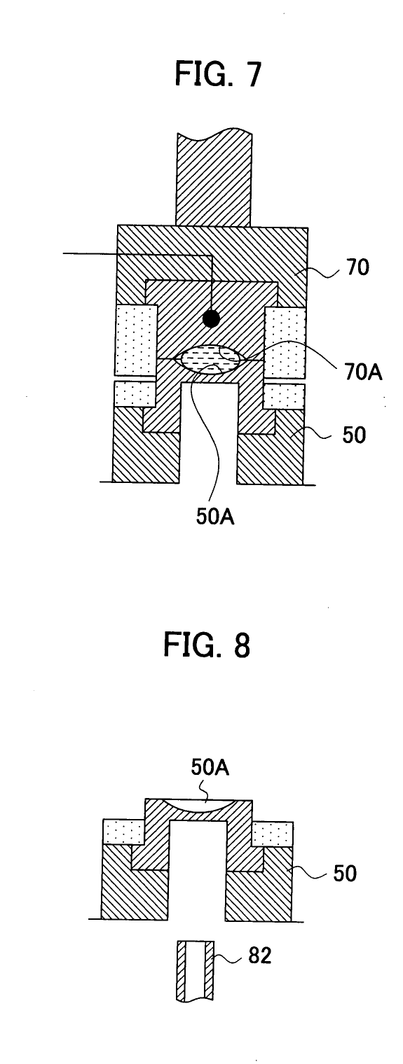

Subsequently, the second mold 50 holding the molten glass block is moved below the third mold 70. As shown in FIG. 7, the third mold 70 is lowered, and the third mold 70 is fit to the second mold 50. Then, the bottom surface of the molten glass block is press formed by the second receiving surface 50A of the second mold 50, and the top surface of the molten glass block is press formed by the recessed shaping surface 70A of the third mold 70. Accordingly, a preform in a projecting shape in both surfaces is obtained. As described above, the third mold 70 is fit to the second mold 50, whereby a preform can be formed highly accurately.

After that, the rotary table is rotated to move the second mold 50 having discharged the preform to a temperature adjusting position. Subsequently, as shown in FIG. 8, a gas ejection nozzle 82 is inserted into the second mold 50 to issue gas such as air, low temperature air, or nitride gas from the gas ejection nozzle 82 to cool the second mold 50 to a temperature of 400 to 550° C. The cooled second mold 50 is again moved below the first mold to repeat the process steps described above.

According to the embodiment, the following advantages are provided. Since the molten glass at high temperature is received by the first mold 20, the temperature of the molten glass block is lowered, and then the molten glass block is moved to the second mold 50 for shaping, it is possible to suppress oxidation of the surface of the second mold 50 as a molding tool. Therefore, it is unnecessary to replace the second mold 50 at an early stage, and a preform can be produced at low cost.

Moreover, the opening/closing mechanism 60 is configured to open and close the first mold 20. Therefore, a glass block received by the first mold 20 can be easily moved to the second mold 50.

Moreover, the opening/closing mechanism 60 is configured to rotate the split dies 30 and 40 downward. Therefore, it is ensured that the split dies 30 and 40 can be opened and closed in a simple structure.

Moreover, the receiving surface 20A is formed in a shape that is widened and opened from below to above. Therefore, it is possible to prevent the application of a horizontal to the surface of a molten glass block, and the molten glass block can be dropped more accurately onto the second mold 50 below.

### Modification 1

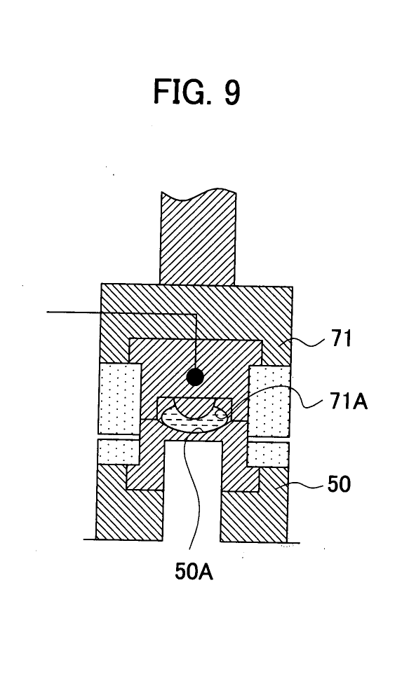

In addition, the present invention is not restricted to the above embodiment, and modifications and improvements within the scope in which the object of the present invention can be achieved should be included in the present invention. For example, in the embodiment, the second mold 50 having the recessed second receiving surface 50A and the third mold 70 having the recessed shaping surface 70A are used to form a preform in a projecting shape in both surfaces. However, as shown in FIG. 9, the center portion of the shaping surface 71A of the third mold 71 is projected to form a preform with one side projected and the other side recessed. In addition to this, the curvature and the shape of the second receiving surface of the second mold and the shaping surface of the third mold can be properly adjusted to form a preform with any shapes and curvatures.

### Modification 2

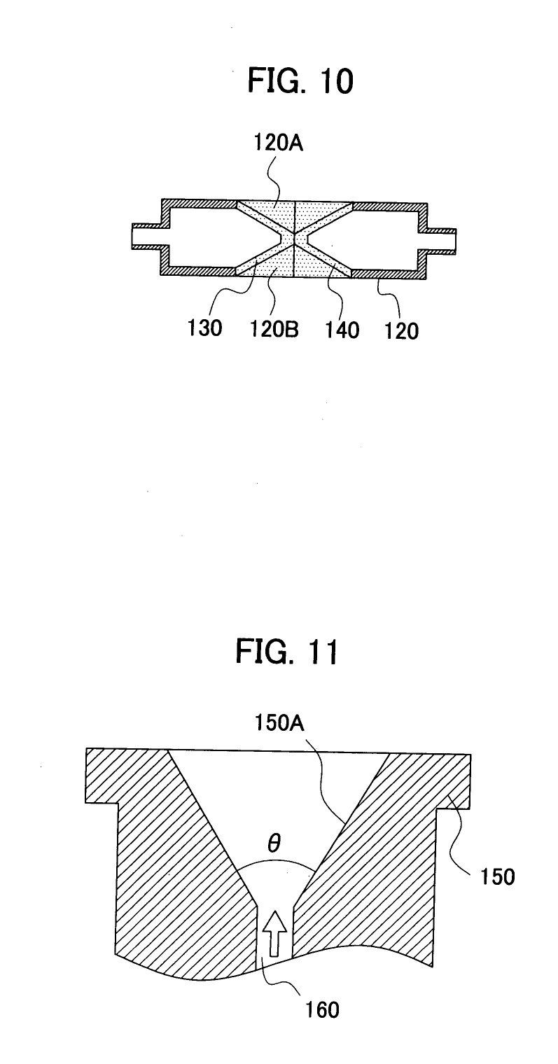

Moreover, as shown in FIG. 10, a first mold 120 is formed with two cavity surfaces 120A and 120B, and the first mold 120 is rotated about the rotating shafts thereof. Thus, the attitude of the first mold 120 may be changed to select a receiving surface from those of the two cavity surfaces 120A and 120B.

### Modification 3

Moreover, FIG. 11 shows another example of the second mold. A second mold 150 has a structure having a second receiving surface 150A which receives a molten glass block formed in a shape that is widened and opened from below to above, and having an ejection port 160 through which gas is issued under the second receiving surface 150A. The structure of the receiving surface 150A is not particularly restricted as long as it is formed in a shape that is widened and opened from below to above. Shapes such as a conical shape and a wineglass shape can be mentioned, but from a viewpoint of forming a spherical preform, a conical shape is preferably used. In the case of a conical shape, an apical angle θ of a cone (an angle formed between two slopes of the second receiving surface 150A) is preferably an angle of 5 degrees or more to 80 degrees or less. Preferably, it is an angle of 10 degrees or more to 60 degrees or less, more preferably, an angle of 20 degrees or more to 40 degrees or less.

Moreover, in FIG. 11, the ejection port 160 is disposed at a single place in the lowermost part of the second receiving surface 150A, but it may be disposed at two places or more. Also for the position of the ejection port 160, it is sufficient that the ejection port is disposed at such a position at which a molten glass block is rotated and a spherical preform is formed, and its position is not restricted to the lowermost part of the receiving surface. For the gas, an inert gas such as air and nitride gas may be used. Moreover, the diameter of the ejection port and the flow rate of gas may be properly adjusted in consideration of the weight and viscosity of the glass block, for example.

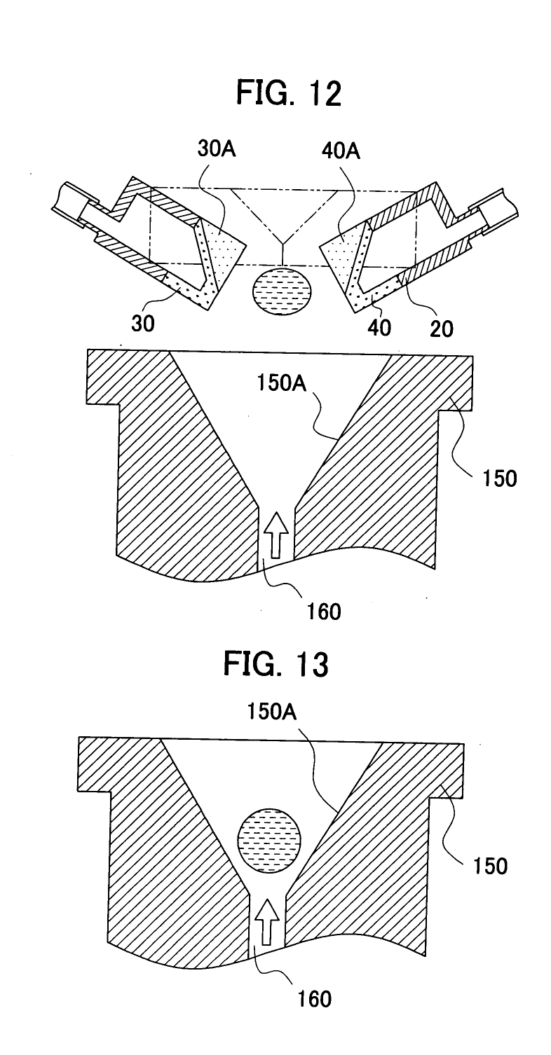

The preform manufacture apparatus using the second mold 150 will be described. Similarly to the method shown in FIG. 4, for molten glass, a molten glass flow is dropped from the nozzle 11 of the dropping unit 10, and the molten glass flow is received at the receiving surface 20A to form a molten glass block. Strings produced at this time are melted into the molten glass block, and then as shown in FIG. 12, the first mold 20 is opened to drop the molten glass block onto the receiving surface 150A of the second mold 150.

As shown in FIG. 13, the dropped molten glass block is formed into a sphere while it is in intermittent contact with the second receiving surface 150A due to the gas issued from the ejection port 160. At this time, since a glass block is formed without on the receiving surface 20A of the first mold 20, no strings are caught and wound in forming, and the formation of striae can be prevented.

### EXAMPLE

For an example, tests were conducted in five ways below.

(1) A molten glass block was dropped from a first mold onto a second mold to measure variations. The number of samples for evaluation was set to 100 samples for each test, and the average value of the distances from the center of the second mold was computed.

### Example 1

The preform manufacture apparatus described above was used (in which the receiving surface of the first mold was formed into a conical shape, and its open/close directions were rotated downward in the opposite directions to each other). In addition, the measurement conditions were as described below.

Distance from the tip end of the nozzle of the dropping unit to the first mold: about 10 mm

Temperature of molten glass to drop: about 900° C. Viscosity log η of molten glass to drop: about 1.2

Time period for which the first mold holds a molten glass block: about 2.0 seconds

Time period to open and close the first mold: about 0.3 seconds

Distance from the first mold to the second mold: about 800 mm

### Example 2

The receiving surface of the first mold was formed into a conical shape, and the open/close directions were the horizontal direction. The other conditions are the same as those of the example 1.

### Example 3

The receiving surface of the first mold was formed into a spherical shape, and the open/close directions were the horizontal direction. The other conditions are the same as those of the example 1.

In Example 1, the average of variations was 15 mm. In Example 2, the average of variations was 100 mm. In Example 3, the average of variations was 150 mm. Therefore, it was revealed from the examples that forming the receiving surface of the first mold into a conical shape can improve the accuracy of drops of a molten glass block from the first mold to the second mold. Moreover, in addition to this, it was revealed that rotating the open/close directions downward in opposite directions to each other can significantly improve the accuracy of drops of a molten glass block from the first mold to the second mold.

(2) A molten glass block was dropped from the first mold to the second mold to measure the capacity of accommodating a molten glass block. In addition, the operating time of the preform manufacture apparatus was measured in three ways, for one minute (the number of samples for evaluation was 20 samples), 10 minutes (the number of samples for evaluation was 200 samples), and 30 minutes (the number of samples for evaluation was 600 samples). The measurement results are as described below.

TABLE 1
Capacity of accommodating a molten glass block

| | Operating time: | Operating time: | Operating time: |
|---|---|---|---|
| | 1 min. | 10 min. | 30 min. |
| | (number of | (number of | (number of |
| | samples for | samples for | samples for |
| | evaluation: 20) | evaluation: 200) | evaluation: 600) |
| Example 4 | 20/20 (100%) | 200/200 (100%) | 600/600 (100%) |
| Example 5 | 11/20 (55%) | 105/200 (53%) | 323/600 (54%) |
| Example 6 | 6/20 (30%) | 54/200 (27%) | 170/600 (28%) |

Here, in Example 4, the preform manufacture apparatus having the same configuration as that of Example 1 was used. In Example 5, the preform manufacture apparatus having the same configuration as that of Example 2 was used. In Example 6, the preform manufacture apparatus having the same configuration as that of Example 3 was used.

According to the examples, it was revealed that forming the receiving surface of the first mold into a conical shape ensures that the molten glass block can be accommodated from the first mold to the second mold. Moreover, in addition to this, it was revealed that rotating the open/close directions downward in opposite directions to each other can better ensure that the molten glass block can be accommodated from the first mold to the second mold.

(3) The final rejection rate of the preform was measured. In addition, the numbers of samples for evaluation were measured in three ways, for 1000 samples, 2000 samples, and 3000 samples. The measurement results are as described below.

TABLE 2
Rejection rate of the perform

| | Number of | | Number of | | Number of | |
|---|---|---|---|---|---|---|
| | samples for | | samples for | | samples for | |
| | evaluation: | | evaluation: | | evaluation: | |
| | 1000 | | 2000 | | 3000 | |
| | Good | Failed | Good | Failed | Good | Failed |
| Example 7 | 1000 | 0 | 1998 | 2 | 2991 | 9 |
| | (100%) | (0%) | (100%) | (0%) | (100%) | (0%) |
| Example 8 | 662 | 338 | 1173 | 827 | 1509 | 1491 |
| | (66%) | (34%) | (59%) | (41%) | (50%) | (50%) |
| Example 9 | 358 | 642 | 651 | 1349 | 873 | 2127 |
| | (36%) | (64%) | (33%) | (67%) | (29%) | (71%) |

Here, in Example 7, the preform manufacture apparatus having the same configuration as that of the Example 1 was used. In Example 8, the preform manufacture apparatus having the same configuration as that of Example 2 was used. In Example 9, the preform manufacture apparatus having the same configuration as that of Example 3 was used.

According to the examples, it was revealed that forming the receiving surface of the first mold into a conical shape can reduce the rejection rate of the preform. Moreover, in addition to this, it was revealed that rotating the open/close directions downward in opposite directions to each other can significantly reduce the rejection rate of the preform.

(4) The second mold (FIG. 11) was used to confirm whether striae was formed by means of a shadow detector and whether a molten glass block bounced out of the second mold by visual inspection. The second receiving surface was formed into a conical shape, and the ejection port for use was placed at a single position at the vertex of the second receiving surface. In addition, the operating time of the preform manufacture apparatus was measured in three ways, for 50 minutes (the number of samples for evaluation was 1000), 100 minutes (the number of samples for evaluation was 2000), and 150 minutes (the number of samples for evaluation was 3000).

### Example 10

An apparatus was used in which the receiving surface of the first mold was formed into a conical shape, and the open/close directions were rotated downward in the opposite directions to each other. In addition, the measurement conditions are as described below.

Distance from the tip end of the nozzle of the dropping unit to the first mold: about 10 mm

Temperature of molten glass to drop: about 900° C. Viscosity log η of molten glass to drop: about 1.2

Time period for which the first mold holds a molten glass block: about 2.0 seconds

Time period to open and close the first mold: about 0.3 seconds

Distance from the first mold to the second mold: about 800 mm

Gas: air

Gas flow rate: 0.5 to 4.0 L/min

### Comparative Example 1

Except that the first mold was not used, the other conditions were the same as those of Example 10.

The measurement results are as described below. According to the example, it was revealed that the first mold is used to prevent striae from being formed. Moreover, it was revealed that bouncing of a molten glass out of the second mold can be reduced in forming a preform.

TABLE 3

| | Number | Example 10 | | Comparative Example 1 | |
|---|---|---|---|---|---|
| | of | Number | Rejection | Number | Rejection |
| | samples | failed | rate | failed | rate |
| Striae | 1000 | 0 | 0% | 500 | 50% |
| | 2000 | 0 | 0% | 1300 | 65% |
| | 3000 | 0 | 0% | 2400 | 80% |
| Bounces | 1000 | 0 | 0% | 350 | 35% |
| out of | 2000 | 40 | 2% | 860 | 43% |
| the mold | 3000 | 90 | 3% | 1650 | 55% |

(5) The sintering to the first mold and the formation of scratches were confirmed visually and by means of a microscope depending on the provision of gold plating on the receiving surface of the first mold. In addition, the operating time of the preform manufacture apparatus was measured in three ways, for 50 minutes (the number of samples for evaluation was 1000), 100 minutes (the number of samples for evaluation was 2000), and 150 minutes (the number of samples for evaluation was 3000).

### Example 11

Gold plating was applied on the receiving surface of the first mold. The other conditions were the same as those of Example 10.

### Example 12

The preform manufacture apparatus having the same configuration as that of Example 10 was used.

The measurement results are as described below. According to the present invention, it was revealed that applying gold plating on the first mold reduces sintering and scratches, and the rejection rate can be decreased.

TABLE 4

| | | | | Comparative Example | |
|---|---|---|---|---|---|
| | Number | Example 11 | | 12 | |
| | of | Number | Rejection | Number | Rejection |
| | samples | failed | rate | failed | rate |
| Sintering | 1000 | 0 | 0% | 450 | 45% |
| and | 2000 | 20 | 1% | 1200 | 60% |
| scratches | 3000 | 90 | 3% | 2250 | 75% |

In the claims:

1. A preform manufacture apparatus comprising:
a first mold configured to receive molten glass; and
a second mold configured to receive a molten glass block moved from the first mold,
wherein the first mold has a receiving surface which receives molten glass, and is dividable into two or more split dies at the receiving surface.

2. The preform manufacture apparatus according to claim 1, further comprising:
a dropping unit configured to drop molten glass; and
a moving unit configured to move a molten glass block from the first mold to the second mold; wherein:
the first mold is disposed below the dropping unit, and the second mold is disposed below the first mold.

3. The preform manufacture apparatus according to claim 2, wherein:
the moving unit is configured to open and close the first mold.

4. The preform manufacture apparatus according to claim 3, wherein:
the moving unit is configured to open the first mold by rotating the split dies downward.

5. The preform manufacture apparatus according to claim 4, wherein:
the receiving surface has a shape that is widened and opened from below to above.

6. The preform manufacture apparatus according to claim 5, wherein: the receiving surface has a pyramidal shape.

7. The preform manufacture apparatus according to claim 6, wherein: the receiving surface has a conical shape, and an apical angle of the cone is an angle of 30 degrees or more.

8. The preform manufacture apparatus according to claim 6, wherein: the receiving surface has a conical shape, and an apical angle of the cone is an angle of 150 degrees or less.

9. The preform manufacture apparatus according to claim 1, wherein:
the first mold is formed with a plurality of cavity surfaces, and
the receiving surface is selected from the plurality of the cavity surfaces.

10. The preform manufacture apparatus according to claim 9, wherein:
the receiving surface is selected from the plurality of the cavity surfaces by changing the attitude of the first mold.

11. The preform manufacture apparatus according to claim 1, wherein an opening width of the first mold is 1.2 times the diameter of a desired preform or more.

12. The preform manufacture apparatus according to claim 1, wherein the receiving surface of one or both of the first mold and the second mold is formed of gold or a gold alloy.

13. The preform manufacture apparatus according to claim 2, wherein the dropping unit drops molten glass having a log η of 7.65 or less (η is a viscosity in poise).

14. The preform manufacture apparatus according to claim 1,
wherein the second mold has a second receiving surface which receives a molten glass block, and
the second receiving surface has a shape that is widened and opened from below to above, having an ejection port through which gas is issued under the second receiving surface.

15. The preform manufacture apparatus according to claim 14, wherein the second receiving surface has a conical shape.

16. The preform manufacture apparatus according to claim 14, wherein a preform to be produced is a spherical preform or, a rough sphere for a polished ball.

17. A precision press forming apparatus configured to apply precision press forming to a preform produced by means of the preform manufacture apparatus according to claim 1.

18. A preform manufacture method of producing a preform from molten glass using a first mold which has a receiving surface that is widened and opened from below to above and which is dividable into two or more split dies at the receiving surface, the method comprising the steps of:
dropping molten glass;
forming a molten glass block in which the dropped molten glass is received at the receiving surface of the mold;
removing a molten glass block out of the mold by dividing the mold into two or more of split dies; and
receiving the molten glass block at a second receiving surface of a second mold and press forming the molten glass block to produce a preform.

19. A preform manufacture method of producing a preform from molten glass using a first mold which has a receiving surface that is widened and opened from below to above and which is dividable into two or more split dies at the receiving surface, the method comprising the steps of:
dropping molten glass;
forming a molten glass block in which the dropped molten glass is received at the receiving surface of the first mold;
removing a molten glass block out of the mold by dividing the mold into two or more split dies; and
receiving the molten glass block at a second receiving surface of a second mold, the surface being formed in a shape that is widened and opened from below to above, and issuing gas from under the second receiving surface to produce a spherical preform.

20. The preform manufacture method according to claim 19, wherein the second receiving surface has a conical shape.

21. The preform manufacture method according to claim 19, wherein in the step of forming, the molten glass block is formed in a state in which the block is intermittently contacted with the second receiving surface.

22. The preform manufacture method according to claim 18, wherein the receiving surface has a pyramid shape.

23. The preform manufacture method according to claim 22, wherein the receiving surface of the first mold is formed into a conical shape, and an apical angle of the cone is an angle of 30 degrees or more.

24. The preform manufacture method according to claim 22, wherein the receiving surface of the first mold is formed into a conical shape, and an apical angle of the cone is an angle of 150 degrees or less.

25. The preform manufacture method according to claim 18,
wherein the first mold is formed with a plurality of cavity surfaces, and
the method comprises the step of selecting a receiving surface in which a receiving surface is selected from the plurality of the cavity surfaces by changing the attitude of the first mold.

26. The preform manufacture method according to claim 18, wherein in the step of removing, the split dies are rotated downward to open the mold for removal.

27. The preform manufacture method according to claim 18, wherein in the step of removing, an opening width of the first mold is 1.2 times the diameter of a desired preform or more.

28. The preform manufacture method according to claim 18, wherein in the step of dropping, molten glass is dropped which has log η of 7.65 or less (η is a viscosity in poise).

29. The preform manufacture method according to claim 18, wherein the receiving surface of one or both of the first mold and the second mold is formed of gold or a gold alloy.

30. A precision press forming method of precision press forming a preform produced according to the preform manufacture method according to claim 18.
